(19) United States
(12) Patent Application Publication
(10) Pub. No.: US 2004/0210716 A1
(43) Pub. Date: Oct. 21, 2004

(54) Apparatus and method for simulating virtual floppy disk and virtual hard disk

(75) Inventor: Yung-Shun Chuang, Hsin-Tien City (TW)

Correspondence Address: RABIN & BERDO, P.C., 1101 14 Street, N.W., Suite 500, Washignton, DC, 20005, US

(73) Assignee: AAEON TECHNOLOGY INC., Hsin-Tien City (JP)

(21) Appl. No.: 10/419,155

(22) Filed: Apr. 21, 2003

(51) Int. Cl. G06F 12/00

(52) U.S. Cl. 711/115

(57) ABSTRACT

Disclosed is apparatus and method for simulating virtual floppy disk (FD) and virtual hard disk (HD). A BIOS extension is stored in a Flash RAM. After powering on, original FD or HD interrupt routines of PC BIOS are replaced by the BIOS extension for processing read or write commands issued by OS and redirecting the read or write commands from the FD or HD to a storage module.

### FIELD OF THE INVENTION

The present invention relates to computer simulation techniques and more particularly to apparatus and method for simulating both a virtual floppy disk (FD) and a virtual hard disk (HD) with improved characteristics.

### BACKGROUND OF THE INVENTION

Information technology has known a rapid, spectacular development leading to an increasing use of computers by people and in almost all trades. Hence, computers have become a ubiquitous tool for both personal and work related tasks. Conventionally, after powering on, a computer (e.g., personal computer (PC) or industrial personal computer (IPC)) runs a Basic Input Output System (BIOS) to detect system and peripheral component(s), load an installed operating system (OS) (e.g., Windows, or MS-DOS), etc. Moreover, BIOS of PC (or IPC) provides a plurality of Interrupt Service Routines (e.g., INTs) including INT0, INT1, . . . , and INT1e to the OS for controlling one or more peripheral component(s).

A number of prior art systems are proposed. For example, both Taiwanese Patent Application No. 91,123,494 entitled “System Having A Virtual Floppy Disk” and Taiwanese Patent Application No. 91,123,493 entitled “System Having A Virtual Floppy Disk Drive” disclosed an apparatus for simulating a virtual floppy disk in computer booting and/or read/write operation.

However, both prior art systems suffered from a disadvantage. For example, it can only simulate a virtual floppy disk (FD) rather than a virtual hard disk (HD). Thus, the need for improvement still exists.

### SUMMARY OF THE INVENTION

It is therefore an object of the present invention to provide apparatus and method for simulating both virtual floppy disk and virtual hard disk in which a BIOS extension is stored in a Flash Random Access Memory (RAM) of the apparatus. After powering on, original floppy disk or hard disk interrupt routines of PC BIOS are replaced by the BIOS extension for processing read or write commands issued by OS and redirecting the read or write commands from the floppy disk or the hard disk to a storage module (e.g., flash memory, or Static Random Access Memory (SRAM)) of the apparatus. As an end, the purpose of simulating both virtual floppy disk and virtual hard disk is achieved. By utilizing this, it is also possible of preventing both floppy disk and hard disk from being damaged or invaded by viruses and increasing booting speed of computer. The present invention is thus applicable to data storage in point-of-sales (POSs), money machines, etc.

In one aspect of the present invention, a reliability higher than that of either conventional floppy disk or hard disk is provided.

In another aspect of the present invention, a storage speed higher than that of either conventional floppy disk or hard disk is provided.

In still another aspect of the present invention, a more compact and safer data store as compared to that of either conventional floppy disk or hard disk is provided.

In a further aspect of the present invention, the apparatus and method described herein are particularly applicable to various types of computers as a means for storing bootstrap programs or important data files.

The above and other objects, features and advantages of the present invention will become apparent from the following detailed description taken with the accompanying drawings.

### BRIEF DESCRIPTION OF THE DRAWINGS

FIG. 1 presents schematically the connection of an apparatus for simulating both virtual floppy disk and virtual hard disk according to the invention;

FIG. 2 is a flow chart showing a sequence of method steps performed by the apparatus during booting;

FIG. 3 is a flow chart showing a sequence of method steps performed by the apparatus after finishing the booting;

FIG. 4 is a flow chart showing a sequence of method steps performed by a new function 08h according to a preferred embodiment of the invention; and

FIG. 5 is a flow chart showing a sequence of method steps performed by a new function 15h according to the preferred embodiment of the invention.

### DETAILED DESCRIPTION OF THE PREFERRED EMBODIMENTS

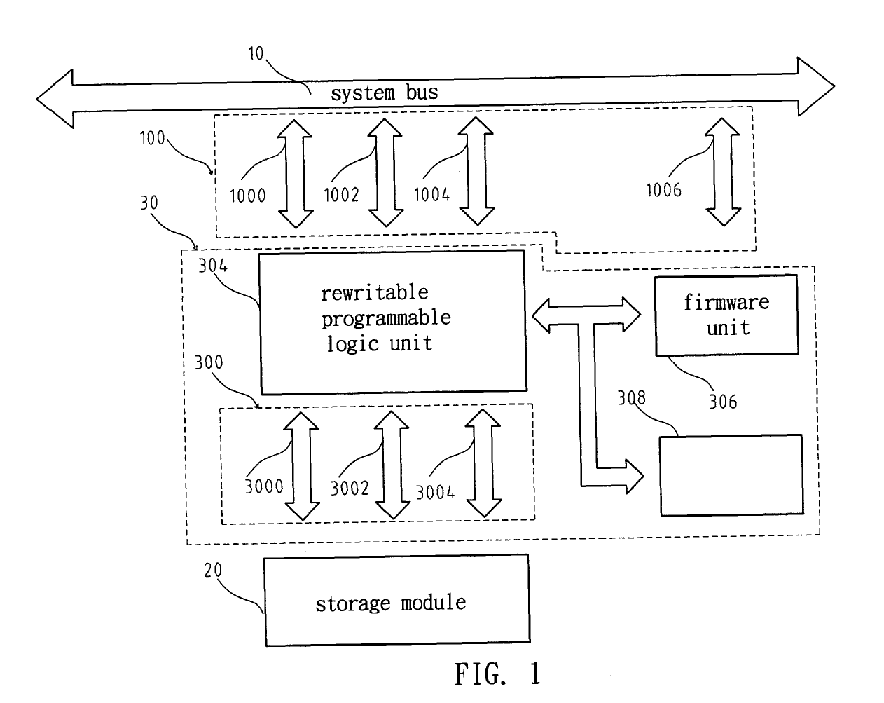

Referring to FIG. 1, there is shown an apparatus for simulating both virtual floppy disk (FD) and virtual hard disk (HD) in accordance with the invention. The apparatus comprises a computer (not shown). The computer is implemented as either a personal computer (PC) or an industrial personal computer (IPC) and comprises a system bus 10, a storage module 20, and a memory module 30. Each component is described in detail below.

The system bus 10 is embedded in the computer. The system bus 10 is an Industry Standard Architecture (ISA) bus, Extended Industry Standard Architecture (EISA) bus, Video Electronic Standards Association (VESA) local bus, or Peripheral Component Interconnect (PCI) bus. The system bus 10 is an ISA bus in this embodiment.

The storage module 20 is embedded in the computer and comprises at least one memory unit having an installed OS. The memory unit may be a Static Random Access Memory (SRAM), Dynamic Random Access Memory (DRAM), Double Data Rate Dynamic Random Access Memory (DDR DRAM), Extended Data Output Random Access Memory (EDO RAM), or a Flash RAM. The memory is implemented as a Flash RAM in the embodiment. The Flash RAM is available from BSI Company, model number BS162L4001TC-70, batch number S3860FY100010, and serial number E 0219.

The memory module 30 is adapted to process commands issued by the OS and redirect the command from a FD, a HD, a virtual FD, or a virtual HD to the storage module 20. The memory module 30 is electrically coupled to the system bus 10. The memory module 30 is in communication with the system bus 10 by means of a first signal 100. Also, the memory module 30 is electrically coupled to the storage module 20. The memory module 30 is in communication with the storage module 20 by means of a second signal 300. A power on self test (POST) program having an interrupt service routine is stored in the memory module 30. The interrupt service routine is adapted to simulate a virtual FD or HD. The interrupt service routine comprises a new INT 13h interrupt routine and a new INT 1Eh interrupt routine.

A user can use a programmable logic burn interface to write a new interrupt routine into the memory module 30 in advance. The new interrupt routine is adapted to simulate a virtual FD or HD. The new interrupt routine comprises a new INT 13h interrupt routine and a new INT 1Eh interrupt routine.

The memory module 30 is implemented as an Electrically Erasable Programmable Read Only Memory (EEPROM) chip or Field Programmable Gate Array (FPGA) chip. The memory module 30 is an EEPROM chip in the embodiment. The EEPROM chip is available from Altera Company, model number EPM7064STC100-10 and batch number W-CG8320213A.

The memory module 30 comprises a rewritable programmable logic unit 304 in communication with both the system bus 10 by means of the first signal 100 and the storage module 20 by means of the second signal 300, a firmware unit 306 electrically coupled to the system bus 10 and being in communication with the system bus 10 by means of the first signal 100 for controlling the rewritable programmable logic unit 304 and the system bus 10, and an address decoding selection unit 308 for controlling the firmware unit 306 and the rewritable programmable logic unit 304, providing address decoding selections, and electrically coupling to both the rewritable programmable logic unit 304 and the firmware unit 306.

The first signal 100 comprises a first address signal 1000 for sending an address of the memory module 30 or the system bus 10 to be processed, a first control signal 1002 for controlling the process of the memory module 30 or the system bus 10, a first data signal 1004 for sending data to be processed by the memory module 30 or the system bus 10, and a first firmware signal 1006 for communicating data with the firmware unit 306 or the system bus 10.

The second signal 300 comprises a second address signal 3000 for sending an address of the memory module 30 or the storage module 20 to be processed, a second control signal 3002 for controlling the process of the memory module 30 or the storage module 20, and a second data signal 3004 for sending data to be processed by the memory module 30 or the storage module 20. Moreover, the OS runs a POST program in conjunction with the memory module 30 after turning on the computer.

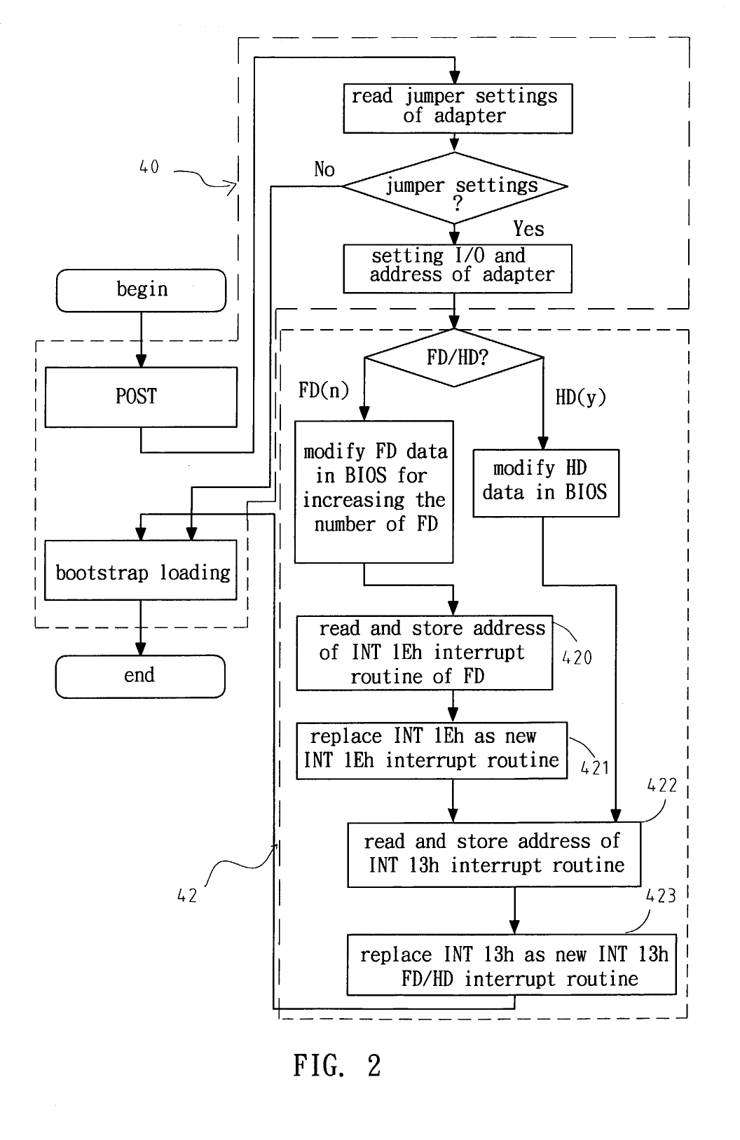

Referring to FIG. 2, there is shown a flow chart showing a sequence of method steps performed by the apparatus during booting. Step 40 comprises executing POST reading jumper settings of adapter, determining whether the jumper settings of adapter are done, and setting I/O and address of the adapter if the jumper settings of adapter are done; and downloading bootstrap. Step 42 is a step of performing a replacement of a new interrupt routine. In detail, it comprises determining whether it is HD or FD after setting I/O and address of the adapter; modifying HD data in BIOS if it is HD prior to going to step 422 else modifying FD data in BIOS for increasing the number of FD and setting FD as A drive or B drive based on the jumper settings prior to going to step 420 of reading and storing the address of INT 1Eh interrupt routine of FD, step 421 of replacing INT 1Eh as new INT 1Eh interrupt routine, and step 422; reading and storing the address of INT 13h interrupt routine (step 422); and replacing INT 13h as new INT 13h FD/HD interrupt routine (step 423) prior to downloading bootstrap in the step 40. Note that in the step 423 there is a sub-step of modifying HD data in BIOS for increasing the number of HD by updating setting of HD and updating the number of HD.

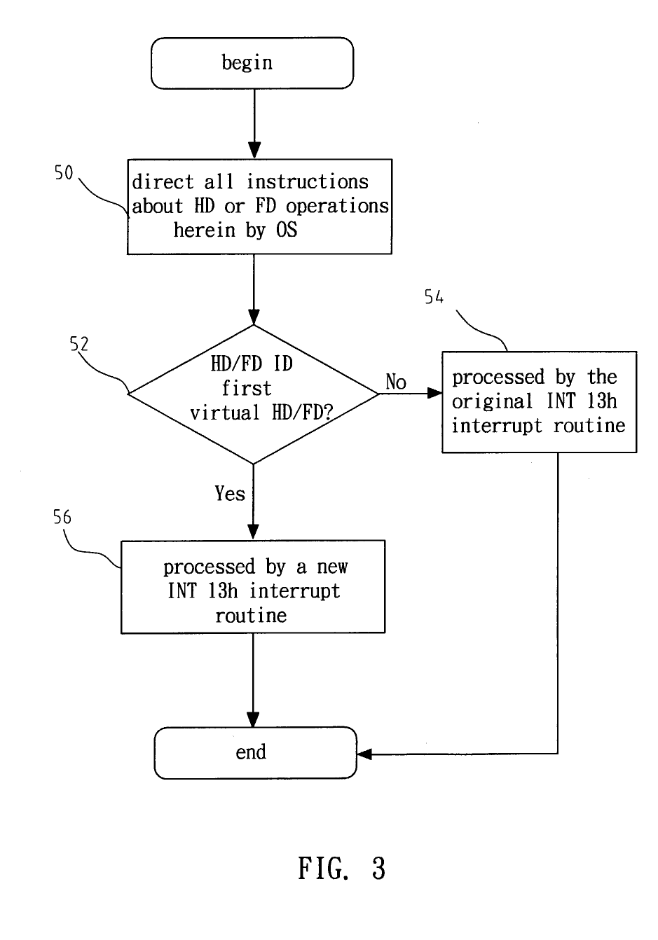

Referring to FIG. 3, there is shown a flow chart showing a sequence of method steps performed by the apparatus after finishing the booting process. At this time, the OS is able to receive instructions from one or more application programs being run. All instructions about HD or FD operations will be directed herein by the OS (step 50). Next, it is determined whether HD/FD ID is the same as a virtual HD/FD (step 52). If not, it means that HD/FD is the physical HD/FD prior to being processed by the original INT 13h interrupt routine (step 54). If yes, it means that the HD/FD is the virtual device (e.g., virtual HD or FD) to be processed by the invention prior to being processed by a new INT 13h interrupt routine (step 56). The processing done by the new INT 13h interrupt routine comprises commanding a new function 08h to process; and commanding a new function 15h to process. The process ends normally after performing step 54 or 56.

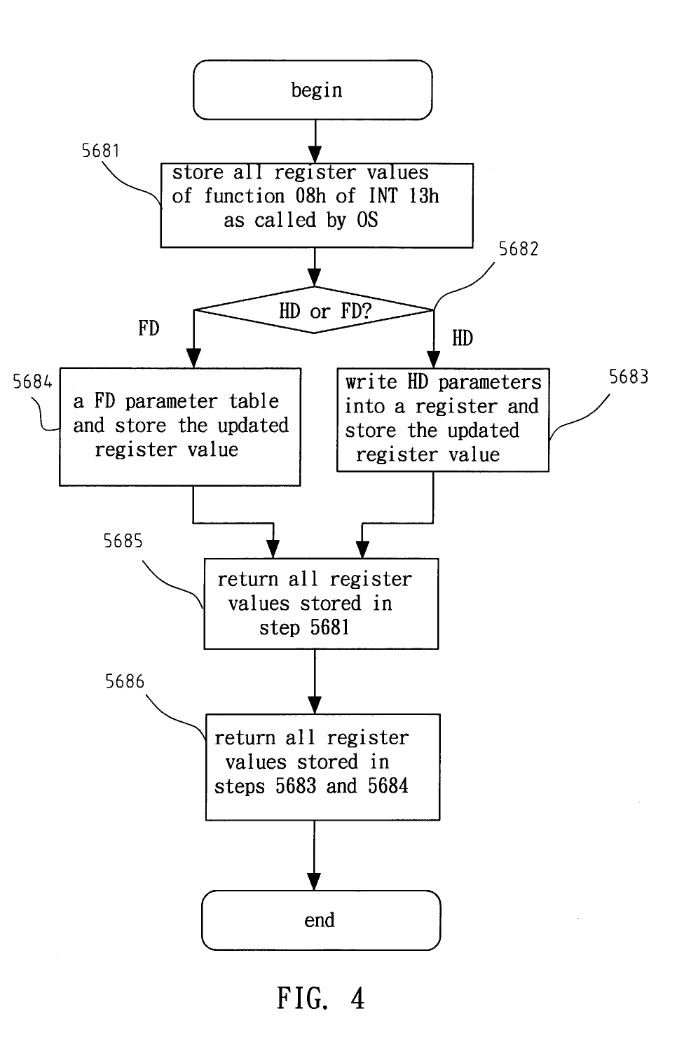

Referring to FIG. 4, there is shown a flow chart showing a sequence of method steps performed by a new function 08h according to a preferred embodiment of the invention. First, store all register values of function 08h of INT 13h as called by OS (step 5681). It is determined whether HD or FD is called (step 5682). Write HD parameters into a register and store the updated register value if HD is called (step 5683). Write FD parameters into a register by looking up a FD parameter table and store the updated register value if FD is called (step 5684). Return all register values stored in step 5681 (step 5685). Return all register values stored in steps 5683 and 5684 (step 5686). A result is sent to a function at an upper layer prior to ending the process.

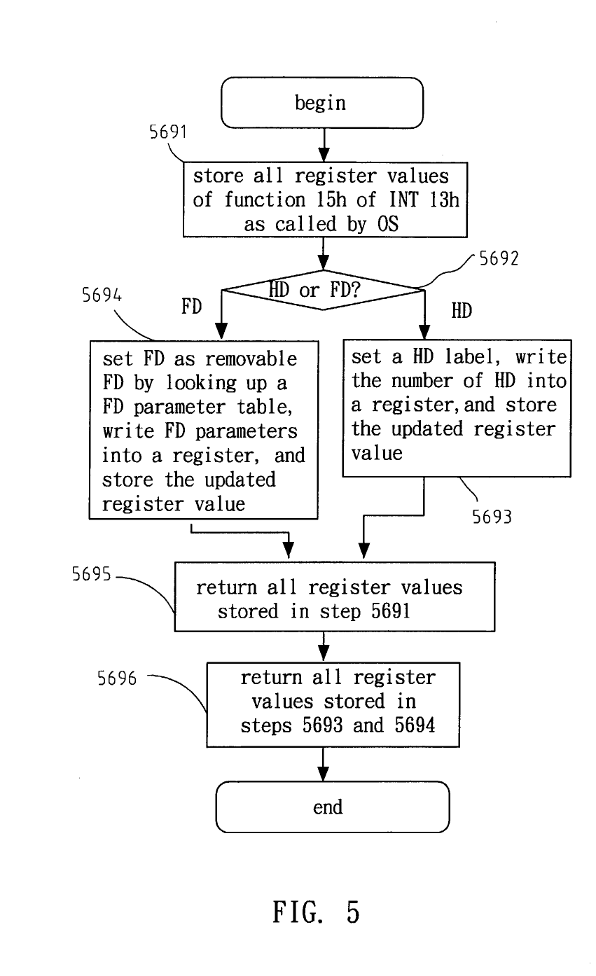

Referring to FIG. 5, there is shown a flow chart showing a sequence of method steps performed by a new function 15h according to the preferred embodiment of the invention. First, store all register values of function 15h of INT 13h as called by OS (step 5691). It is determined whether HD or FD is called (step 5692). Set a HD label, write the number of HD into a register, and store the updated register value if HD is called (step 5693). Set FD as removeable FD by looking up a FD parameter table, write FD parameters into a register, and store the updated register value if FD is called (step 5694). Return all register values stored in step 5691 (step 5695). Return all register values stored in steps 5693 and 5694 (step 5696). A result is sent to the function at the upper layer prior to ending the process.

While the invention has been described by means of specific embodiments, numerous modifications and variations could be made thereto by those skilled in the art without departing from the scope and spirit of the invention set forth in the claims.

What is claimed is:

1. An apparatus for simulating a virtual floppy disk (FD) and a virtual hard disk (HD) including a computer comprising:
a system bus in the computer;
storage means in the computer, the storage means including at least one memory unit having an installed operating system (OS); and
memory means for processing commands issued by the OS and redirecting the command from a FD or a HD to the storage means, the memory means being electrically coupled to the system bus, being in communication with the system bus by means of a first signal, being electrically coupled to the storage means, and being in communication with the storage means by means of a second signal,
wherein the OS runs a bootstrap in conjunction with the memory means after turning on the computer.

2. The apparatus of claim 1, wherein the computer is an industrial personal computer (IPC).

3. The apparatus of claim 1, wherein the computer is a personal computer (PC).

4. The apparatus of claim 1, wherein the memory unit is a Static Random Access Memory (SRAM).

5. The apparatus of claim 1, wherein the memory unit is a Dynamic Random Access Memory (DRAM).

6. The apparatus of claim 1, wherein the memory unit is a Double Data Rate Dynamic Random Access Memory (DDR DRAM).

7. The apparatus of claim 1, wherein the memory unit is an Extended Data Output Random Access Memory (EDO RAM).

8. The apparatus of claim 1, wherein the memory unit is a Flash Random Access Memory (Flash RAM).

9. The apparatus of claim 1, wherein the memory means is operative to store a power on self test (POST) program having an interrupt service routine therein.

10. The apparatus of claim 1, wherein the system bus is an Industry Standard Architecture (ISA) bus.

11. The apparatus of claim 1, wherein the system bus is an Extended Industry Standard Architecture (EISA) bus.

12. The apparatus of claim 1, wherein the system bus is a Video Electronic Standards Association (VESA) local bus.

13. The apparatus of claim 1, wherein the system bus is a Peripheral Component Interconnect (PCI) bus.

14. The apparatus of claim 1, wherein the memory means is adapted to store a new interrupt routine written by a programmable logic burn interface in advance and the memory means comprises:
a rewritable programmable logic unit being in communication with both the system bus by means of the first signal and the storage means by means of the second signal;
a firmware unit electrically coupled to the system bus and being in communication with the system bus by means of the first signal for controlling both the rewritable programmable logic unit and the system bus; and
an address decoding selection unit for controlling both the firmware unit and the rewritable programmable logic unit, providing address decoding selections, and electrically coupling to both the rewritable programmable logic unit and the firmware unit.

15. The apparatus of claim 1, wherein the first signal comprises:
a first address signal for sending an address of the memory means or the system bus to be processed;
a first control signal for controlling a processing of the memory means or the system bus;
a first data signal for sending data to be processed by the memory means or the system bus; and
a first firmware signal for communicating data with the firmware unit or the system bus.

16. The apparatus of claim 1, wherein the second signal 300 comprises:
a second address signal for sending an address of the memory means or the storage means to be processed,
a second control signal for controlling a processing of the memory means or the storage means; and
a second data signal for sending data to be processed by the memory means or the storage means.

17. The apparatus of claim 1, wherein the memory means is an Electrically Erasable Programmable Read Only Memory (EEPROM) chip.

18. The apparatus of claim 1, wherein the memory means is a Field Programmable Gate Array (FPGA) chip.

19. The apparatus of claim 9, wherein the interrupt service routine is adapted to simulate a virtual FD or HD and the interrupt service routine comprises a new INT 13h interrupt routine and a new INT lEh interrupt routine.

20. The apparatus of claim 14, wherein the new interrupt routine is adapted to simulate a virtual FD or HD and the new interrupt routine comprises a new INT 13h interrupt routine and a new INT 1Eh interrupt routine.

21. A method for simulating a virtual FD and a virtual HD comprising the steps of:
(a) executing a POST; and
(b) performing a replacement of a new interrupt routine.

22. The method of claim 21, wherein the step (b) comprises:
(b1) replacing an INT 13h as a new INT 13h interrupt routine; and
(b2) replacing an INT 1Eh as a new INT 1Eh interrupt routine.

23. The method of claim 22, wherein the step (b1) comprises (b11) modifying HD data in BIOS for increasing the number of the HD.

24. The method of claim 23, wherein the step (b11) comprises:
updating a setting of the HD, and updating the number of the HD.

25. A method for simulating a virtual FD and a virtual HD comprising the steps of:
(a) determining whether a HD or FD is a virtual HD or FD;
(b) If the determination in the step (a) is positive, processing the HD or the FD by a new INT 13h interrupt routine; and
(c) If the determination in the step (a) is negative, processing the HD or the FD by an original INT 13h interrupt routine.

26. The method of claim 25, wherein the new INT 13h interrupt routine in the step (b) performs the sub-steps of:
(b1) commanding a new function 08h to process; and
(b2) commanding a new function 15h to process.

27. The method of claim 26, wherein the new function 08h performs the sub-steps of:
(b11) storing all register values of function 08h of INT 13h as called by an OS;
(b12) determining whether the HD or the FD is called;
(b13) writing HD parameters into a first register and storing the updated first register value if the HD is called;
(b14) writing FD parameters into a second register by looking up a FD parameter table and storing the updated second register value if the FD is called;
(b15) returning all of the register values stored in the step (b11); and
(b16) returning all of the register values stored in the steps (b13) and (b14).

28. The method of claim 26, wherein the new function 15h performs the sub-steps of:
(b21) storing all register values of function 15h of INT 13h as called by an OS;
(b22) determining whether the HD or the FD is called;
(b23) setting a HD label, writing the number of the HD into a first register, and storing the updated first register value if the HD is called;
(b24) setting the FD as a removeable FD by looking up a FD parameter table, writing FD parameters into a second register, and storing the updated second register value if the FD is called;
(b25) returning all of the register values stored in the step (b21); and
(b26) returning all of the register values stored in the steps (b23) and (b24).
